(19) United States
(12) Patent Application Publication
(10) Pub. No.: US 2004/0162939 A1
(43) Pub. Date: Aug. 19, 2004

(54) Retrieval of records from linear data storage media

(76) Inventor: Paul Frederick Bartlett, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/677,114

(22) Filed: Oct. 2, 2003

(30) Foreign Application Priority Data
Oct. 2, 2002 (GB) 0222763.5

(51) Int. Cl. G06F 12/00

(52) U.S. Cl. 711/111; 711/4

(57) ABSTRACT

Locating a plurality of data records stored linearly on a data storage medium includes: reading data relating to the plurality of data records stored on the data storage medium from a memory device associated with the data storage medium; determining a position of the data record on the data storage medium for each data record to be read; and determining an order in which to read the plurality of data records from the data storage medium to minimize time needed to read the plurality of data records.

### BACKGROUND OF THE INVENTION

1. Field of the Invention

The present invention relates to data storage, and more particularly, although not exclusively, to retrieving specific records from a data storage.

2. Description of the Related Art

In order to store digital electronic data, it is known to use magnetic tape cartridges comprising a pair of reels, which are inserted into a tape drive unit having a plurality of read/write heads. Typically, such magnetic tape storage devices may be used to back up data generated by a host device, e.g.—a computer, or to store data generated by test or measurement instruments.

For example, the SureDrive data storage unit manufactured by Hewlett Packard is capable of storing 8 GBytes of data on a single cassette cartridge. In the SureDrive series 12000 unit, by including a plurality of cassette cartridges, a data storage capacity 48 Gbytes is achieved in a single compact drive assembly of dimensions on the order of a few tens of centimeters.

Known tape drive units operate to draw an elongated magnetic tape past a read/write head.

Known tape data storage cartridges can be provided with a memory device for storage of data describing the content of the respective tape data storage cartridge.

FIG. 1 is a perspective view of a known tape data storage cartridge having a memory device. The memory device can be read from and written to via a wireless signal transmitted from a tape data storage device to the memory device, when the memory device is inserted in a port of tape data storage device. The wireless signal transfers data to and from the memory circuit, as well as providing power to the memory circuit.

Typically, in prior art tape cartridges having a memory device, data describing the content of the tape is stored, which enables a summary of the content of the tape data storage device to be read, without the need to wind the whole length of the tape past a read/write head.

FIG. 2 is two views of a section of tape data storage cartridge 200, indicating the approximate position and orientation of a prior art memory device 201 in the casing of the data cartridge. The memory device 201 is positioned near a periphery of the casing and within the casing, such that as the cartridge 200 is inserted into a tape drive unit, signals can be read from and written to the memory device by an inductively coupled wireless signal.

The cartridge memory device 201 contains data describing information concerning the cartridge, in particular the content of the cartridge 200. In the cartridge memory device 201, there is a page called the ‘tape directory’ containing information for each of 96 wrap sections on the tape within the cartridge 200. This information includes the number of records and file marks in each wrap section. A wrap section is half the length of the tape. Therefore, there are two wrap sections per wrap, and 48 wraps per tape.

In a tape data storage cartridge having a linear tape data storage medium, a elongated band of magnetic tape data storage medium is drawn past a read/write head of a tape drive unit for reading data from the tape, and writing data to the tape.

Typically, for a linear tape format such as the LTO (Linear Tape Open) format, a read/write head remains static, and the tape is drawn past the read/write head at speeds of up to 4.1 meters per second. Reading and writing of data onto the tape may be carried out in both forward and reverse pass directions of the tape relative to the head. A plurality of parallel data tracks may be simultaneously read from or recorded onto the tape using a read/write head comprising a plurality of spaced apart read/write elements.

### SUMMARY OF THE INVENTION

An object of the present invention is to quickly and efficiently locate data blocks along a length of tape, while minimizing an access time to access a particular block of data for reading data, or to access a position for writing of a block of data.

According to a first aspect of the present invention there is provided a method of locating a plurality of data records stored linearly on a data storage medium and determining an order in which to read said plurality of data records, said method comprising:

reading data relating to said plurality of data records stored on said data storage medium from a memory device associated with said data storage medium;

determining a position of said data record on said data storage medium for each data record to be read; and

determining an order in which to read said plurality of data records from said data storage medium to minimize time needed to read said plurality of data records.

According to a second aspect of the present invention there is provided a computer capable of communicating with a data storage device for reading and writing a plurality of data records on a data storage medium, said computer comprising:

a component arranged to input data from a memory device associated with said data storage medium, said data describing a plurality of data records stored on a data storage medium;

a component arranged to determine positions on said data storage medium of said plurality of data records from said data describing said position; and

a component arranged to determine a read sequence for reading said plurality of data records from said data storage medium to minimize time needed to read said plurality of data records.

According to a third aspect of the present invention there is provided a method of retrieving a plurality of data records from a tape data storage medium, wherein said plurality of data records are stored on a plurality of wraps of said tape data storage medium, each wrap extending between a first end of tape and a second end of tape, said method comprising:

determining a number of records on each wrap;

determining a number of a target record which is to be retrieved;

determining on which of said plurality of wraps said target record resides;

determining a distance of said target record along said wrap on which said target record resides, from one of said ends of tape, in order to obtain a physical location data of said data record; and

reading said plurality of data records by moving said tape in a first direction relative to a read head;

wherein a plurality of said data records are read consecutively along a length of said tape, without stopping movement of said tape relative to said read heads.

According to a fourth aspect of the present invention there is provided a tape drive unit, said tape drive unit comprising a transponder device adapted to read data from a cartridge memory device of a tape data storage cartridge inserted in said tape drive unit, said tape drive unit comprising:

a means for reading data from said cartridge memory device relating to a set of data records stored on said data storage medium;

a means for determining a position of said data record on said data storage medium for each data record to be read; and

a means for determining an order in which to read said plurality of data records from said data storage medium to minimize time needed to read said plurality of data records.

According to a fifth aspect of the present invention there is provided a method of locating a particular wrap on which a target record is located, the method comprising:

setting a cumulative number of records equal to zero;

setting a wrap number equal to zero;

determining the number of records arranged on each wrap;

determining whether or not the number of records on a wrap is greater than a target number of file records;

if the number of records on a wrap is not greater than the target number of file records, then the particular wrap has been located; and

alternatively, if the number of records on a wrap is greater than the target number of file records, incrementing the wrap number, calculating the cumulative number of records, and determining whether or not the cumulative number of records is less than the target record;

if the cumulative number of records is less than the target record, then again incrementing the wrap number, calculating the cumulative number of records, and determining whether or not the cumulative number of records is less than the target record; and

alternatively, if the cumulative number of records is not less than the target record, then again incrementing the wrap number, then the particular wrap has been located.

According to a sixth aspect of the present invention there is provided a method of sorting a list of records to be retrieved into an optimized retrieval sequence, the method comprising:

(1) setting a current record position equal to zero;

(2) examining a list of target records and locating a final record that is closest to, but beyond a current target record in a same tape direction;

(3) determining whether or not the final record located in step (2) is available;

(4) if it has been determined in step (3) that the final record located in step (2) is available, then selecting the next record;

(5) repositioning read head to new record position along tape in same tape direction, taking into account settling distance for switching wraps;

(6) reading record;

(7) returning to step (1);

(8) if it has been determined in step (3) that the final record located in step (2) is not available, then examining the list of target records and locating a record that is closest to an end of tape or beginning of tape to which reading of records is currently progressing;

(9) determining whether or not the record located in step (8) is available;

(10) if the record located in step (8) is available, then repositioning read head to beyond the new record position along tape in same tape direction and then reversing the tape direction;

(11) returning to step (1);

(12) if the record located in step (8) is not available, then determining whether or not all records have been retrieved;

(13) if it has been determined in step (12) that all records have been retrieved, then stopping process; and

(14) if it has been determined in step (12) that all records have not been retrieved, then returning to step (1).

Other aspects of the invention are as recited in the claims herein. The scope of the invention is limited only by the features of the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a perspective view of a prior art tape data storage device, having an associated memory device for storage of data describing data content of a linear tape data storage medium contained within the cartridge;

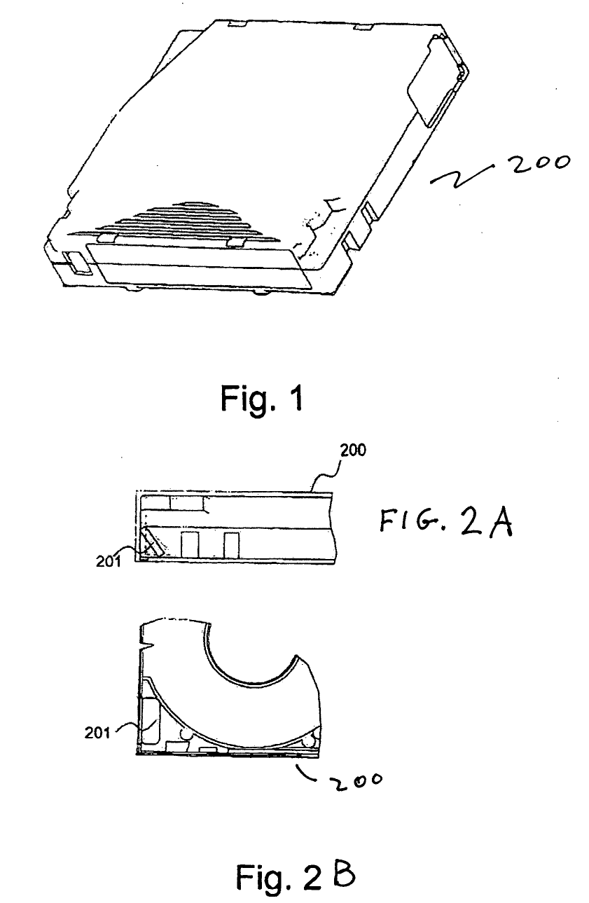

FIG. 2 is two views of a section of a tape data storage cartridge, showing a cartridge memory device installed in a casing of the data storage device;

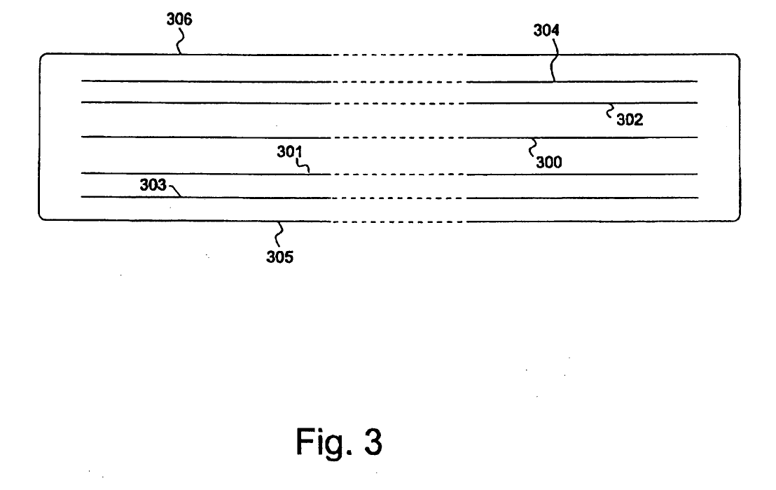

FIG. 3 is a view of a physical layout of data recorded along an elongate band of magnetic tape data storage medium;

FIG. 4 is a view of an example of physical positions of data records stored on a linear tape data storage medium, wherein data records are written in a forward and a reverse direction along the data storage medium;

FIG. 5 is a perspective view of a host computer, and an associated tape drive unit for storing back-up records according to a specific example embodiment in accordance with the present invention;

FIG. 6 is a view of components of a host computer and tape drive unit for performing a file record retrieval process according to an embodiment of the present invention;

FIG. 7 is a view of a logical relationship between a host application and a tape drive unit for reading file record locations from a cartridge memory and for operating a specific file record retrieval method according to an embodiment of the present invention;

FIG. 8 is a view of process steps carried out by a file retrieval application in the host computer for driving the tape drive unit retrieve file records in an optimized manner;

FIG. 9 is a view of process steps carried out in finding a wrap number that a particular target record is located on;

FIG. 10 is a view of process steps for finding a physical position on a tape of each of a plurality of file records to be retrieved; and

FIG. 11 is a view of process steps carried out by a host computer for determining an optimum sequence of reading of file records by a tape drive unit.

### DETAILED DESCRIPTION

There will now be described by way of example specific implementations and modes contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

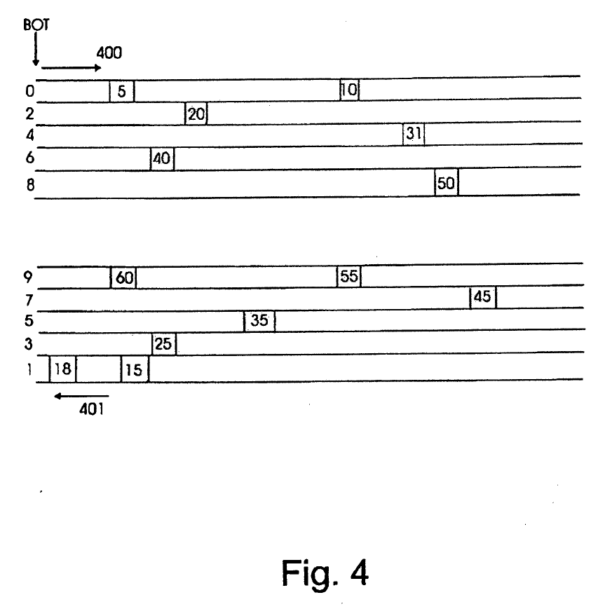

FIG. 3 is a view of a physical layout of data recorded along an elongate band of magnetic tape by a read/write head of a magnetic data recording device as the tape is drawn past the head according to a specific method in accordance with an embodiment of the present invention.

The read/write head contains a plurality of read elements and a plurality of write elements arranged to read or write a plurality of physical tracks of data along the tape simultaneously, resulting in physical tracks 300-304 which are recorded parallel to each other along a length of the tape. The plurality of read/write elements are spaced apart from each other in a direction transverse to a direction of movement of the tape, typically by a distance of the order 200 μm.

Each read/write element is capable of reading or writing a physical track of width of the order 20 μm or so.

The read/write head records a plurality of band groups along the tape in a path as shown in FIG. 3 herein. Each band group contains a plurality of bands, each band comprising a plurality of physically recorded data tracks. Substantially a complete length of the tape is wound past the static read/write head in a single pass.

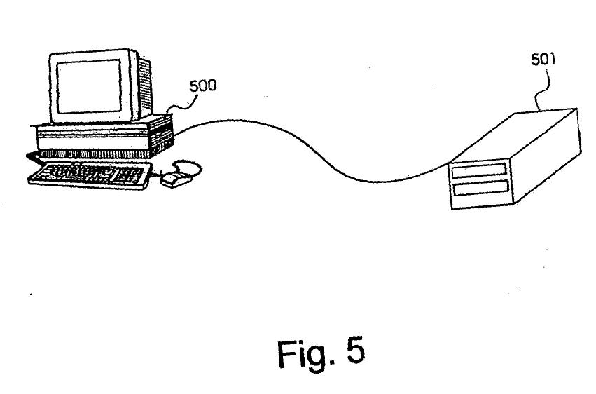

FIG. 4 is a view of a specific example of storage of data records on a linear tape data storage medium, in a data storage cartridge having an associated cartridge memory in which locations of files on the tape can be read from the memory when the cartridge is in a tape drive unit.

In the example of FIG. 4, data records are each 50 MBytes in size. Therefore, in a tape data storage device having a data storage capacity of 100 GBytes, there may be up to 2000 individual records.

In the example shown, there are 96 wrap sections on the tape. Information stored in the cartridge memory in a ‘tape directory’ page includes data describing a number of records in each wrap section, and data describing a number of file marks in each wrap section. In this example, a wrap section extends over half the physical length of the tape. Therefore, there are two wrap sections per wrap, and 48 wraps per tape.

In this specification, the term ‘record’ is used to mean a data record, having a header file marker identifying the beginning of the data record, a data section containing a payload data; and optionally an end of file marker, identifying the end of the record.

Individual records are stored in data blocks along a length of the tape.

Where individual data records are of a same size, or approximately same size as each other, the blocks will be spaced at approximately regular intervals along the length of the tape.

Given a logical position (block number on tape) one can work out which wrap this block resides on, and it can then be calculated a likely position down the tape at which a block number resides by using the ratios A/B, and the length of the wrap, where A is the offset number of blocks to the target from the beginning of the wrap, and B is the number of blocks on the wrap.

Having determined an estimated physical distance from the beginning of a wrap to a target data block, then records that are stored on even numbered wraps can be separated from those stored on odd numbered wraps. The linear tape is driven relative to the read head such that records on even numbered wraps are collected first, in the first direction of the tape, and then records of odd numbered wraps are collected secondly, in a second direction of the tape.

In FIG. 4 herein, the direction of movement of the tape in a first direction is shown by first arrow 400. A plurality of data records, each nominally having an equal length, are stored along a first plurality of tracks numbered 0, 2, 4, 6 and 8, from a beginning of tape (BOT) in a first direction.

Typically when writing data, the tape moves in a first direction between the beginning of tape and the end of tape (EOT) recording data blocks consecutively, on a first track (track 0) and then returns in a second direction relative to the write head, from the end of tape toward to the beginning of tape, writing further subsequent data blocks along a second track (track 1).

On reaching the beginning of tape, the tape drive writes further consecutive data blocks beginning on a third track (track 2) in the first direction 400 from the beginning of tape to the end of tape.

On reaching the end of tape, the write head moves across again, transversely to a direction of movement of the tape, to align with a fourth track (track 3) and traverses from the end of tape to beginning of tape in the second direction 401, writing further consecutive data blocks along the fourth track.

Similarly, for fifth and subsequent tracks, the tape is drawn past the write head in the first and then the second directions between the beginning of tape and end of tape and between the end of tape and beginning of tape respectively.

To align with each track, the write head moves across the length of the tape transversely to the main length of the tape.

When a blank tape is first written with a plurality of data blocks, the data blocks may be numbered consecutively, and for data blocks in a format where data blocks always have a same or approximately same size, the positions of the data blocks along the length of tape are approximately constant over time.

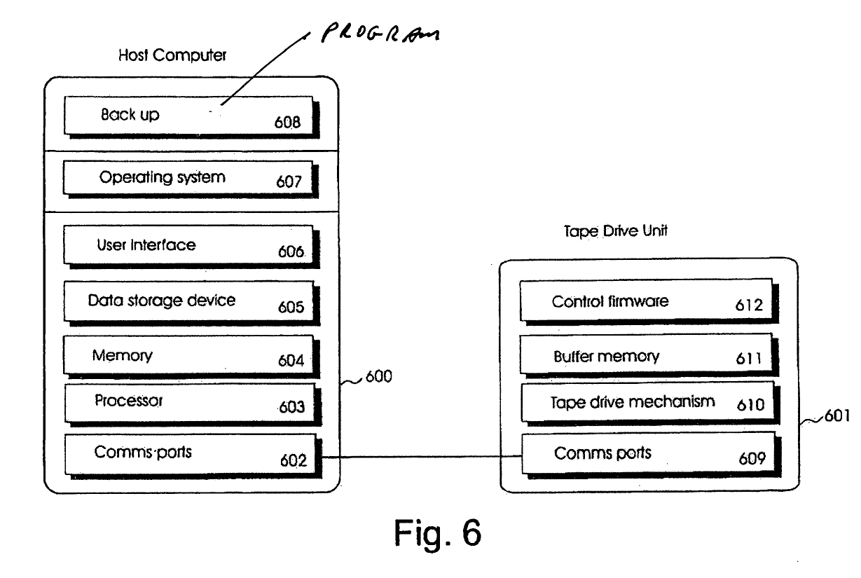

FIG. 5 is a view of a host computer and an associated tape drive unit 501 including a tape data storage device of cartridge type having a cartridge memory facility.

Data is transferred from the host computer to the data storage device. A write channel in the data storage device writes data to a linear tape data storage medium as a plurality of data records arranged as data blocks along a length of the linear tape data storage medium. The data can be retrieved from the tape by drawing the tape past a read head, which reads the data blocks, and output data records for retrieval by the host computer 500.

A control program can be resident either in the host computer, or in the tape data storage device, for performing a data retrieval process for retrieving specific data records from the linear tape data storage medium according to a specific method of the present invention.

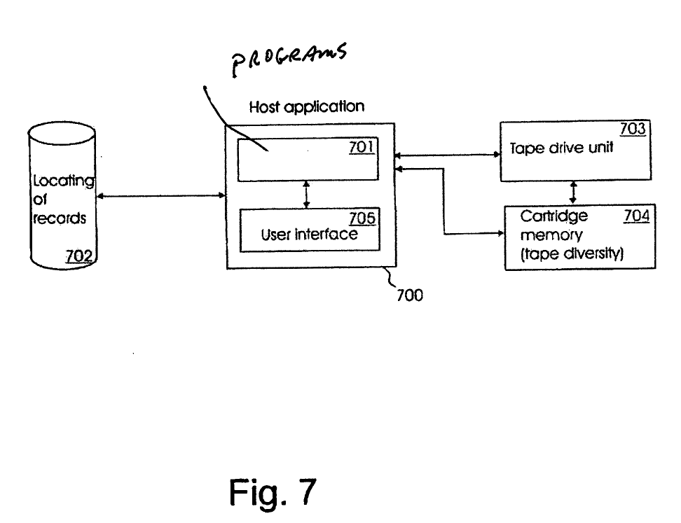

FIG. 6 is a view of components of a host computer 600 and a tape drive unit 601 according to a specific embodiment of the present invention. The host computer 600 comprises a communications port 602 for communicating with the tape drive unit; a processor 603; a memory device 604; one of more data storage devices 605, for example a hard disk data storage device; a user interface 606 including a visual display monitor, keyboard, and pointing device such as a mouse; an operating system 607, for example, the known Microsoft Windows, Linux, or Unix, operating system and a backup program 608 which manages a backup of data to the tape drive unit, and interfaces with the tape drive unit.

The tape drive unit 601 comprises a communications port 609 for communicating with a host computer for receiving back-up data and returning back up data; a tape drive mechanism 610, including a port for accepting a tape data storage cartridge, one or more drive motors, and a read/write head; a buffer memory 611 for storing data temporarily when being written to and read from a tape data storage device; and a control block 612, such as an application specific integrated circuit (ASIC) containing control programs for controlling the tape drive mechanism, and for controlling passage of data between the tape drive unit and the external host computer:

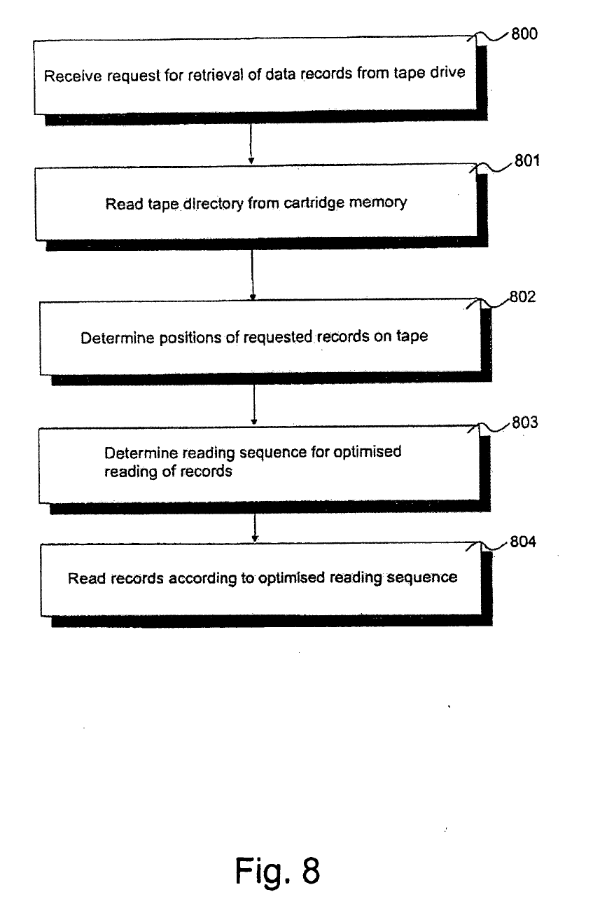

FIG. 7 is a logical overview of communications between the host computer and the tape drive unit of FIGS. 5 and 6. Host back up application 700 contains a set of programs 701 for locating files on the internal data storage device 702 of the host computer, and for locating file records on the data storage device by communicating with tape drive unit 703, and via the tape drive unit 703 reading the tape directory section of the cartridge memory 704 of the data storage medium. The programs 701 also communicate with the user interface 705 for enabling user intervention in the location of files and back-up procedures.

The programs 701 includes a set of retrieval programs for locating and retrieving records on the tape data storage medium. The retrieval programs use the information that is available in the cartridge memory to increase the speed of data retrieval from a tape storage medium. The data on the cartridge memory indicates how many file markers there are in each half of a wrap. Since each record has one file marker, this information is equivalent to the information of how many records there are in each half wrap. For formats in which the records are each of similar size, it can be determined from the file marker location information, how far along the tape each record is situated. Therefore, using the information from the tape directory, the programs can determine an approximate distance along the tape of each record.

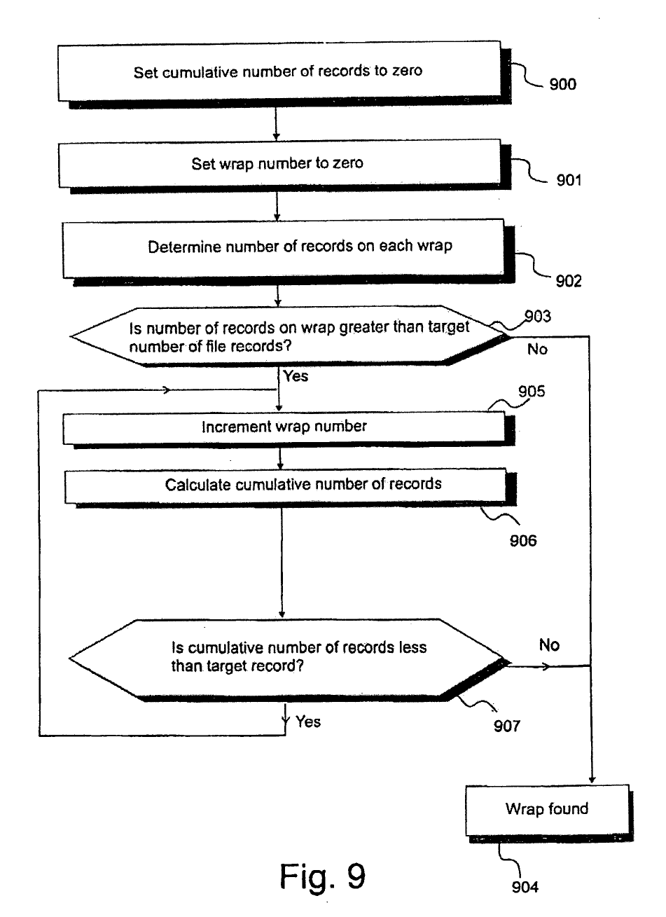

FIG. 8 is a view of overall process steps carried out in retrieving a set of data records from a data storage medium.

In process 800, a request for a retrieval of specified data records is received from the tape data storage device. The data records may be located at various locations along the tape, on different wraps, and the data records may need to be read in different directions.

In process 801, the cartridge memory is interrogated and the tape directory stored on the cartridge memory is read. The tape directory contains the numbers of file markers on wraps of the tape.

In process 802, the physical positions of individual records stored on the tape are determined by performing calculations based upon a prior knowledge of an average record size in bytes, a prior knowledge of the amount of space which a predetermined amount of data physically occupies on the tape, and a number of the file marker.

In process 803, having determined a physical position for each record on tape that is required to be retrieved, a reading sequence of the tape is determined to optimally read all of the file records in an optimized sequence.

In process 804, the tape drive unit reads the records according to the optimized reading sequence.

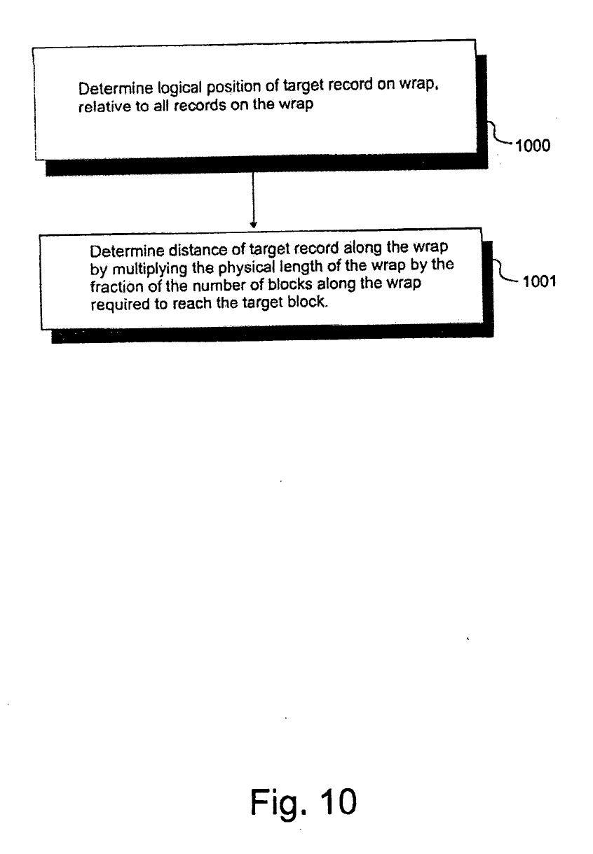

FIG. 9 is a view of process steps carried out by the program for finding a wrap on which a target record is located.

Initially, a parameter CumulativeNumberOfRecords which maintains a cumulative data describing the number of records on the plurality of wraps which the tape drive has searched is set to zero in step 900.

In step 901, a parameter WrapNumber that describes the number of the wrap on the tape, is set to zero.

The CumulativeNumberOfRecords parameter maintains a running total of the number of records along the tape, corresponding to the particular wrap number on the tape that is being incremented as the WrapNumber.

In process 902 the number of records on the first wrap is determined by reading the wrap number from the tape directory, and assigning a number of records to that wrap number.

In process 903, if the number of records on the wrap is found to be more than the target number of the filed record to be found, then the wrap on which that particular target record has been found in process 904, and the wrap number for that particular target file record.

However, if in step 903, the number of records on the wrap is less than the target number, than the wrap number is incremented in process 905, and in process 906, the cumulative number of records taking into account all wrap numbers examined so far, is calculated. This is done by assigning to the incremented wrap number, and number of records on the wrap, and adding this to the previous number of records on the wrap, to create a cumulative running total of number of records on all wraps so far examined.

In process 906, if the cumulative number of records is less than the record number of the target record, then the wrap number is further incremented in process 905 and the cumulative total is recalculated in process 906.

However, if in process 907, the cumulative number of records exceeds the number of the file record which is to be found, then the wrap in which that file record exists has now been found to be the presently examined wrap number in step 904.

A pseudo code for an program to find the wrap that a target record is located on may be as follows:

CumulativeNumberOfRecords=0;

WrapNumber=0;

NumberOfRecordsOnWrap=TapeDirectory [WrapNumber]. NumberOfRecordsOnWrap;

IF NumberOfRecordsOnWrap<TargetRecord THEN

DO

CumulativeNumberOfRecords=CumulativeNumberOfRecords+NumberOtRecordsOnWrap;

WrapNumber=WrapNumber+1;

NumberOfRecordsOnWrap=TapeDirectory[WrapNumber].NumberOfRecordOnWrap; WHILE CumulativeNumberOfRecords+NumberOfRecordsOnWrap<TargetRecord;

END IF;

The parameter WrapNumber holds the number of the wrap on which the target record can be found. The parameter NumberOfRecordsOnWrap holds the number of records on the target wrap, and the parameter CumulativeNumberOfRecords is the number of records on tape up until the end of the previous wrap.

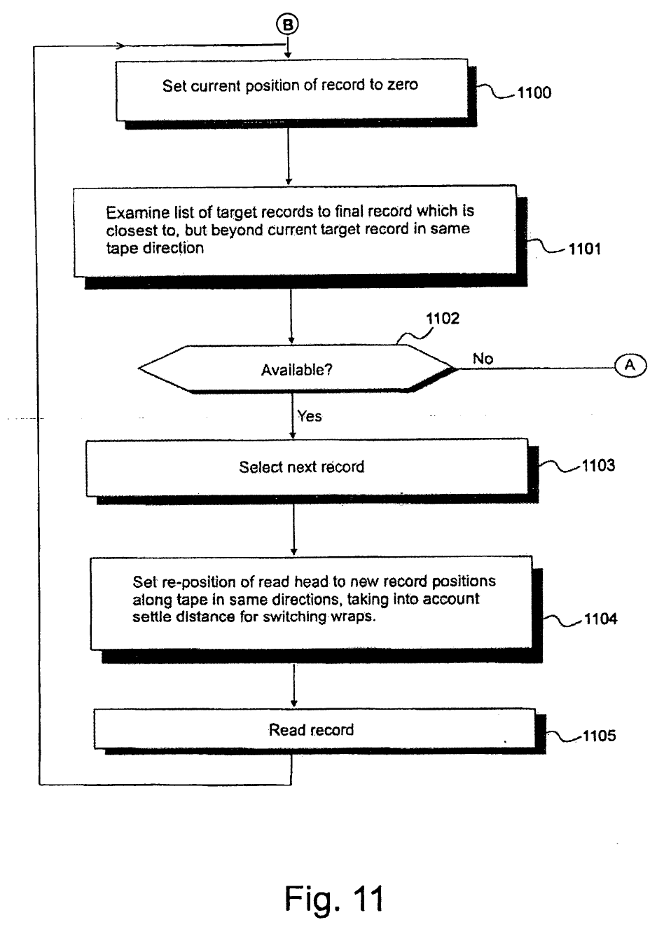

FIG. 10 is a view of process steps carried out by the retrieval program for finding a physical position along the tape of a particular target record. The wrap number of the target record is already found by the process steps schematically with reference 8 herein.

In process 1000, a logical position of the target record to be found on the wrap which contains the target record is determined. The logical position of the record is determined relative to the other records on the wrap.

In process 1001 a physical distance from the beginning of tape of the target record is determined by multiplying a physical wrap length by the position of the target record on the wrap, and dividing by the number of records on the wrap.

A pseudo code for a program for carrying out the process of FIG. 10 may be as follows:

TargetRecordOnWrap=TargetRecord−CumulativeNumberOfRecords; DistanceDownWrapOfTarget=(WRAP_LENGTH*TargetRecordOnWrap)/NumberOfRecordOnWrap;

The program determines the distance down the wrap, to the target record.

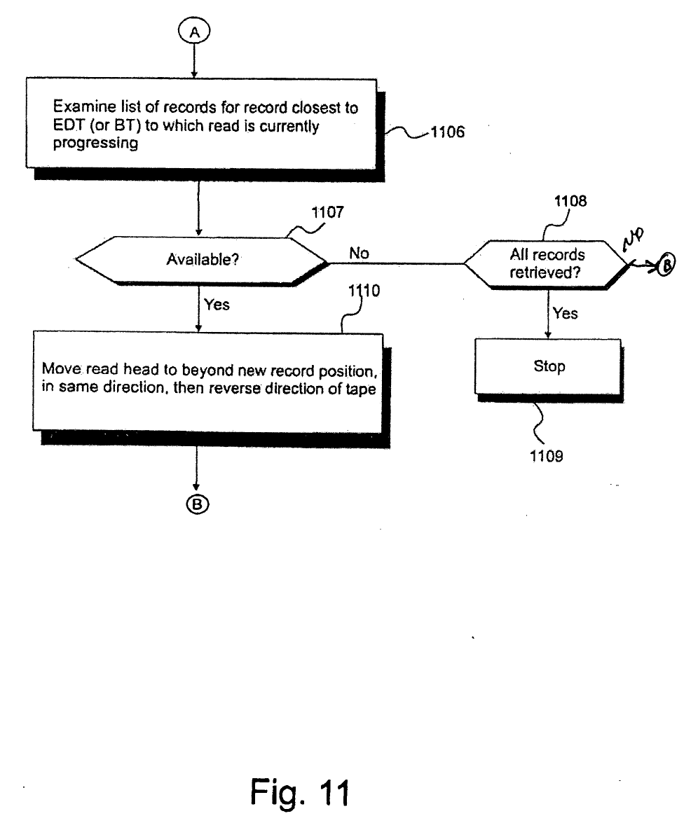

FIG. 11 is a view of process steps carried out by the retrieval program for sorting a list of records to be retrieved into an optimized retrieval sequence. The objective of the program is to minimize tape direction reversals, and minimize the amount of forward direction and reverse direction winding of the tape that occurs between the reading of records.

The program attempts to seek an order to record retrieval, which starts at one end of the tape, keeps the tape moving in the same direction, reading the records in a sequence in which they pass the read head as the tape moves in that same direction, moving the read head across from wrap to wrap, where records are stored on different wraps in the same direction, and reversing the tape once only in the optimum case, for reading records stored in the opposite direction, and maintaining the tape movement in the opposite direction such that records in the opposite direction in different wraps are read in the order in which they appear as the tape passes the read head. Ideally, the tape would pass the read head in the first direction once only, and pass the read head in the reverse direction once only traversing from beginning of tape to end of tape, and from end of tape to beginning of-tape respectively (or vice versa, from end of tape to beginning of tape, then reversing, traversing from beginning of tape to end of tape) so that all records on all wraps of the tape which are to be retrieved in one retrieval set are read with the minimum amount of tape movement relative to the read head, and without multiple tape direction reversals, and without multiple stop/start events of the tape.

Before sorting a set of required file records into an optimized sequence, each of those file records will already have been assigned a wrap number, and a distance down the wrap, from either a beginning of tape or end of tape as appropriate.

Therefore, the complete set of file records to be obtained in one retrieval sequence in known in advance of that sequence, and the wrap number position and distance along the wrap is known for each file record to be retrieved. Having determined this information, the program can determine an optimum set of tape forwards and reverses, and movements of the read head across the tape, to read off the file records in the minimum time.

In process 1100, a current position of a first record to be read is set to be zero. At this point, the read head is on a particular wrap for that record number, and has a particular position along the tape, at the beginning of that record.

In process 1101, the host computer examines the list of target records, to find the record which is closest to the current record at which the head is positioned, but which is the next record along the tape in the same direction, irrespective of whether that) record is on that same wrap as present or not. Having found an available record, the host selects that next record in process 1103.

For the next record, the program determines the wrap number and the physical position along the tape in the same direction, taking into account a settle distance. The settle distance is a distance that the tape traverses past the read head, while the read head is moving over across from one wrap to another, where the new record is to be found on a different wrap to the previous record.

The settle distance may vary depending on how far across the tape the read head moves. Where the new record is found on the same wrap as the previous record, then the settle distance is zero, since the head does not need to move across wraps.

After the head has been moved across the tape to a new wrap (if necessary), and once the tape has been moved in the same direction to the new record, then reading of the file record proceeds in process 1105. The process then repeats from step 1100, looking for the next record along the tape in the same direction, so that the tape drive unit does not have to reverse direction, unless there are no more records to be found in that same direction.

If in step 1103, it is found that there are no more file records available in the same direction, then in process 1106 the host examines the list of file records to find the file record closest to the end of tape to which the read head is currently traveling, so that the read head can travel relative to the tape towards the end of tape, and having passed the newly identified file record in the reverse direction, can then reverse the tape and start reading in the reverse direction.

Conversely, if the tape is already on a return traversal in the second direction, heading towards the beginning of tape, and has read all records in that direction, and there are further records to be read in the reverse direction (the first direction), then the read head travels relative to the tape towards the beginning of tape, to a position which goes just beyond the beginning of the new file record, and then reverses direction to the first direction, to start reading the next record in the other (first) direction. It is not necessary for the read head to travel all the way towards the end of the tape or beginning of tape, only to go beyond the start of the new file record in the opposite direction, so that is can start reading the new file record once the tape direction has reversed.

In process 1107, having examined the list of records, after reading all the records in one direction, if the host cannot find any records to be read in the other direction, then this means that all records have been read 1108 and the process stops in step 1109.

If the tape drive has already read all records in a first initial direction and then reverses the tape to start reading records in the second direction, and has already read the first record in the second direction, if there are further records to be read, then the process continues in the reverse direction starting from process 1100 again until all records are read.

Pseudo code for a program to implement sorting a set of records into an optimized sequence may be as follows:

Do

PositionOfLastRecord=0;

RecordPosition=0;

Do

Get RecordNumber of record that is closest to, but beyond RecordPosition on a 30 wrap in the same direction;

IF RecordNumber is valid, RecordPosition=Record.DistanceDownWrapOfTarget+SettleDistance

Retrieve record with index RecordNumber;

END IF;

WHILE RecordNumber is valid;

WHILE there are still more records to retrieve;

The step Get RecordNumber would return an invalid number if there are no more Records in this direction.

In the above sequence, the parameter SettleDistance is to allow time for the drive to switch wraps between records. This distance may be dependant upon a number of factors, such as tape speed, and the time to switch from one wrap to another.

While example embodiments have been described with regard to a linear tape open format, the present invention is not limited to any particular data storage format, but is generic and may be used for any data storage format having a plurality of parallel tracks where data records are stored sequentially along those tracks. The specific methods may be used for reading data from formats where file records are written in one direction only, as well as for applications in data storage formats where file records are written in a first direction of travel of a data storage medium past a read/write head, and are stored in a second direction that is opposite to the first direction.

In the foregoing description, example embodiments have been described, in which functionality for determining an optimum order to read records from a linear data storage medium is provided by way of an program operating in a host computer device.

However, alternative embodiments are possible in which functionality for determining an optimum read sequence of records from a data storage medium is provided within a tape drive unit itself, in which case the tape drive unit receives from the host computer a list of data records to be retrieved, and the tape drive unit itself determines an order in which to retrieve data records from a linear data storage medium by reading data stored on a cartridge memory.

The functionality may be provided in the data storage unit by a program operating a processor within that data storage unit, or by firmware operating programs and methods as described herein for data retrieval.

What is claimed is:

1. A method of locating a plurality of data records stored linearly on a data storage medium and determining an order in which to read said plurality of data records, said method comprising:
reading data relating to said plurality of data records stored on said data storage medium from a memory device associated with said data storage medium;
determining a position of said data record on said data storage medium for each data record to be read; and
determining an order in which to read said plurality of data records from said data storage medium to minimize time required to read said plurality of data records.

2. The method as claimed in claim 1, wherein determining a position of each data record comprises:
determining a location of said data record in a direction transverse to a read direction along said data storage medium; and
determining a location of said data record along a length of a line along which said data record is written.

3. The method as claimed in claim 1, wherein determining a position of each data record comprises:
determining a location of said data record in a direction transverse to a read direction along said data storage medium; and
determining a location of said data record along a length of a line along which said data record is written;
wherein said line along which said data record is written comprises a line between a beginning of said data storage medium and an end of said data storage medium.

4. The method as claimed in claim 1, wherein determining an order in which to read said plurality of data records comprises:
identifying a set of said data records which can be read in a first direction of said data storage medium relative to a read head; and
identifying a set of said data records that can be read in a second direction of said data storage medium relative to said read head.

5. A program storage device, readable by a machine, tangibly embodying a program to perform a method for controlling a computer to retrieve data from a data storage medium, said method comprising:
receiving data relating to a plurality of data records stored on a data storage medium from a memory device associated with said data storage medium; and
determining positions on said data storage medium of said plurality of data records using the received data; and
determining a read sequence for reading said plurality of data records from said data storage medium to minimize time needed to read said plurality of data records.

6. The program storage device as claimed in claim 5, wherein determining a read sequence to control a data storage drive unit for moving a data storage medium past a read head comprises:
reading a plurality of records recorded on said data storage medium in a first direction, in an order in which they are presented to the read head while the data storage medium is traveling in said first direction relative to said read head; and
reading a second plurality of data records in an order in which they are presented to said read head, as said data storage medium passes said read head in a second direction relative to said read head, said second direction being opposite to said first direction.

7. A computer adapted to communicate with a data storage device to enable reading and writing a plurality of data records on a data storage medium, said computer comprising:
a component adapted to receive data relating to a plurality of data records stored on a data storage medium from a memory device associated with said data storage medium;
a component adapted to determine positions on said data storage medium of said plurality of data records using the received data; and
a component adapted to determine a read sequence to read said plurality of data records from said data storage medium to minimize time needed to read said plurality of data records.

8. The computer as claimed in claim 7, wherein said component adapted to determine a read sequence is adapted to control a data storage drive unit for moving a data storage medium past a read head; and
wherein a plurality of records recorded on said data storage medium are read in a first direction, in an order in which they are presented to the read head while the data storage medium is traveling in said first direction relative to said read head; and
wherein a second plurality of data records are read in an order in which they are presented to said read head, as said data storage medium passes said read head in a second direction relative to said read head.

9. A method of retrieving a plurality of data records from a tape data storage medium, wherein said plurality of data records are stored on a plurality of wraps of said tape data storage medium, each wrap extending between a first end of a tape and a second end of said tape, said method comprising:
determining a number of records on each wrap;
determining a number of a target record which is to be retrieved;
determining on which of said plurality of wraps said target record resides;
determining a distance of said target record along said wrap on which said target record resides, from one of said first and second ends of said tape to obtain a physical location data of said data record; and
reading said plurality of data records by moving said tape in a first direction relative to a read head;
wherein a plurality of said data records are read consecutively along a length of said tape, without stopping movement of said tape relative to said read heads.

10. The method as claimed in claim 9, further comprising:
reversing a direction of said tape relative to said read head and reading a further plurality of said data records in a second direction, without stopping said movement of said tape relative to said read head, said second direction being opposite to said first direction.

11. The method as claimed in claim 9, further comprising:
reversing a direction of said tape relative to said read head and reading a further plurality of said data records in a second direction, without stopping said movement of said tape relative to said read head, said second direction being opposite to said first direction; and
wherein said reading a further plurality of said data records comprises moving said read head in a direction transverse to a direction of movement of said tape during a pass of said tape relative to said read head, so that said read head reads a plurality of different data tracks written to said tape.

12. A tape drive unit, comprising a transponder device adapted to read data from a cartridge memory device of a tape data storage cartridge inserted in said tape drive unit, said tape drive unit comprising:
a means for reading data from said cartridge memory device relating to a plurality of data records stored on said data storage medium; and
a means for determining a position of said data record on said data storage medium for each data record to be read; and
a means for determining an order in which to read said plurality of data records from said data storage medium to minimize time needed to read said plurality of data records.

13. A method of locating a particular wrap on which a target record is located, the method comprising:
setting a cumulative number of records equal to zero;
setting a wrap number equal to zero;
determining the number of records arranged on each wrap;
determining whether or not the number of records on a wrap is greater than a target number of file records;
if the number of records on a wrap is not greater than the target number of file records, then the particular wrap has been located; and
alternatively, if the number of records on a wrap is greater than the target number of file records, incrementing the wrap number, calculating the cumulative number of records, and determining whether or not the cumulative number of records is less than the target record;
if the cumulative number of records is less than the target record, then again incrementing the wrap number, calculating the cumulative number of records, and determining whether or not the cumulative number of records is less than the target record; and
alternatively, if the cumulative number of records is not less than the target record, then again incrementing the wrap number, then the particular wrap has been located.

14. A method of sorting a list of records to be retrieved into an optimized retrieval sequence, the method comprising:
(1) setting a current record position equal to zero;
(2) examining a list of target records and locating a final record that is closest to, but beyond a current target record in a same tape direction;
(3) determining whether or not the final record located in step (2) is available;
(4) if it has been determined in step (3) that the final record located in step (2) is available, then selecting the next record;
(5) repositioning read head to new record position along tape in same tape direction, taking into account settling distance for switching wraps;
(6) reading record;
(7) returning to step (1);
(8) if it has been determined in step (3) that the final record located in step (2) is not available, then examining the list of target records and locating a record that is closest to an end of tape or beginning of tape to which reading of records is currently progressing;
(9) determining whether or not the record located in step (8) is available;
(10) if the record located in step (8) is available, then repositioning read head to beyond the new record position along tape in same tape direction and then reversing the tape direction;
(11) returning to step (1);
(12) if the record located in step (8) is not available, then determining whether or not all records have been retrieved;
(13) if it has been determined in step (12) that all records have been retrieved,
